(19) United States
(12) Patent Application Publication
(10) Pub. No.: US 2026/0124908 A1
(43) Pub. Date: May 7, 2026

(54) LID OPENING AND CLOSING DEVICE OF VEHICLE

(71) Applicant: TOYOTA JIDOSHA KABUSHIKI KAISHA, Toyota-shi (JP)

(72) Inventor: Takuji UEMURA, Toyota-shi (JP)

(73) Assignee: TOYOTA JIDOSHA KABUSHIKI KAISHA, Toyota-shi (JP)

(21) Appl. No.: 19/355,223

(22) Filed: Oct. 10, 2025

(30) Foreign Application Priority Data
Nov. 1, 2024 (JP) 2024-192641

(51) Int. Cl. B60K 15/05; B60L 53/16

(52) U.S. Cl. CPC B60K 15/05; B60L 53/16; B60K 2015/0515

(57) ABSTRACT

A lid opening and closing device includes a lid plate. The lid plate covers an opening portion. A switch is disposed in the opening portion. The switch performs an opening and closing drive of the lid plate. A through-hole is perforated in the lid plate at a portion facing the switch. Further, a cap is provided on the lid plate. The cap is movable forward and backward inside the through-hole in a penetration direction.

### CROSS-REFERENCE TO RELATED APPLICATION

This application claims priority to Japanese Patent Application No. 2024-192641 filed on Nov. 1, 2024. The disclosure of the above-identified application, including the specification, drawings, and claims, is incorporated by reference herein in its entirety.

### BACKGROUND

### 1. Technical Field

The present specification discloses a lid opening and closing device of a vehicle.

### 2. Description of Related Art

An opening portion is provided on an outer panel of the vehicle. A power supply module or a fuel supply module is installed in the opening portion. The opening portion is closed by a lid body referred to as a lid. For example, in Japanese U.S. Pat. No. 7,207,563 (JP 7207563 B), a lock of the lid is released by pushing the lid in a vehicle inner side in a closed state.

### SUMMARY

Meanwhile, a switch for opening and closing the lid may be provided in the power supply module or the fuel supply module. That is, the switch is disposed on a back surface side of the lid. In such a case, the lid pushes down the switch by pushing the lid to an inner side in a vehicle width direction.

Here, a stopper that restricts a stroke of the lid may be provided in the power supply module or the fuel supply module. In a plane of the lid, a portion in contact with the stopper is restricted from proceeding to the vehicle inner side. In such a case, pushing down the switch by bending a portion of the lid between the portion in contact with the stopper and the switch is required. Depending on a rigidity of the lid, a load required to push down the switch may be excessive.

Therefore, in the present specification, a lid opening and closing device of a vehicle that is possible to reduce an operation load required to push down a switch is disclosed.

The present specification discloses the lid opening and closing device of the vehicle. An opening portion is provided on an outer panel of the vehicle. The lid opening and closing device opens and closes the opening portion. In addition, the lid opening and closing device includes a plate. The plate covers the opening portion. A switch is disposed in the opening portion. The switch performs an opening and closing drive of the plate. A through-hole is perforated in the plate at a portion facing the switch. Further, a cap is provided on the plate. The cap is movable forward and backward inside the through-hole in a penetration direction.

With the configuration, the switch can be pushed down only by pushing the cap.

In addition, in the configuration, the cap may be connected to the plate via a sealing member. The sealing member seals the through-hole.

With the configuration, sealing properties of the plate are ensured.

In addition, in the configuration, the switch and the cap may be in contact with each other in a case where the plate is in a closed state.

From a viewpoint of exterior design, an allowable range is set for a protrusion height or a depression depth of an exposed surface of the cap with respect to an exposed surface of the plate. A position of the exposed surface of the cap is maintained at a constant value by bringing the switch into contact with the cap. That is, the protrusion height and the depression depth are managed with high accuracy as compared to a case where the cap is in a floating state.

In addition, in the configuration, the cap may include an outer piece and an inner piece. The outer piece is exposed to an outside of the vehicle. The inner piece faces the outer piece. The sealing member is sandwiched between the outer piece and the inner piece.

With the configuration, the sealing properties are ensured by sandwiching the sealing member between the inner piece and the outer piece.

In addition, in the configuration, the sealing member may include a center portion, an outer ring, and an elastic portion. The center portion holds the cap. The outer ring surrounds the center portion. The elastic portion connects the center portion and the outer ring. Further, the lid opening and closing device of the vehicle includes a holding ring. The holding ring sandwiches the outer ring together with the plate.

With the configuration, the sealing properties are ensured by sandwiching the sealing member between the plate and the outer ring.

In addition, in the configuration, the outer ring may be provided with a seal protrusion having an annular shape. The seal protrusion is provided on at least one of a facing surface with the plate or a facing surface with the holding ring.

With the configuration, the seal protrusion is crushed in a case where the outer ring is sandwiched between the plate and the holding ring. Accordingly, high sealing properties can be obtained as compared to a case where the seal protrusion is not provided.

With the lid opening and closing device of the vehicle disclosed in the present specification, it is possible to reduce the operation load required to push down the switch.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a front side surface of a vehicle;

FIG. 2 is a side view illustrating a case where a lid opening and closing device of a vehicle according to the present embodiment is closed;

FIG. 3 is a side view illustrating a case where the lid opening and closing device of the vehicle according to the present embodiment is open;

FIG. 4 is a view illustrating a cross section taken along the line IV-IV in FIG. 2;

FIG. 5 is an exploded perspective view illustrating a lid opening and closing device of a vehicle according to another example of the present embodiment; and

FIG. 6 is a view illustrating a cross section taken along the line IV-IV of the lid opening and closing device of the vehicle according to another example of the present embodiment.

### DETAILED DESCRIPTION OF EMBODIMENTS

A lid opening and closing device of a vehicle according to an embodiment will be described with reference to the drawings. Shapes, materials, numbers, and numerical values described below are merely examples for description. The shapes and the like can be appropriately changed according to specifications of the lid opening and closing device of the vehicle. In addition, hereinafter, equivalent elements in all the drawings are denoted by the same reference numerals.

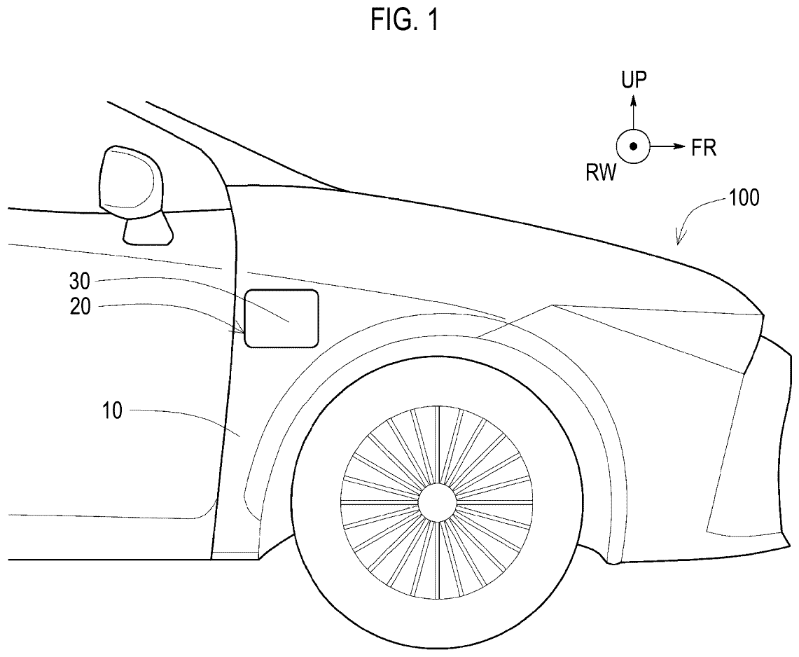

In addition, in FIGS. 1 to 4 and 6, an orthogonal coordinate system consisting of an FR axis, an RW axis, and a UP axis is used in order to indicate a position or a direction of each of the configurations. The FR axis is a vehicle front-rear direction axis of which a forward direction of the vehicle is a positive direction. The RW axis is a vehicle width direction axis of which a right side of the vehicle is a positive direction. The UP axis is a vehicle up-down direction axis of which an upward direction is a positive direction.

### 1. Overall Configuration

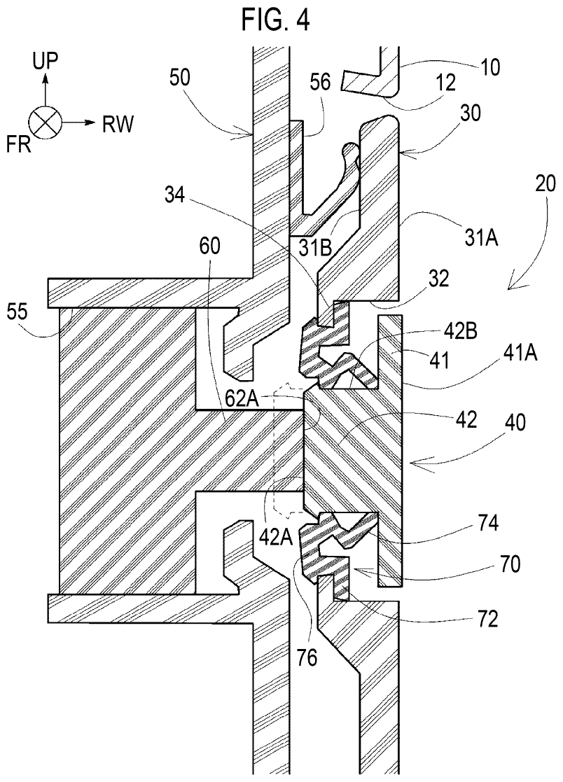

With reference to FIG. 1, a lid opening and closing device 20 according to the present embodiment is provided on an outer panel of a vehicle 100. In FIG. 1, a fender panel 10 is illustrated as the outer panel. The lid opening and closing device 20 is provided on the fender panel 10. As illustrated in FIG. 4 to be described later, the lid opening and closing device 20 includes a lid plate 30, a cap 40, a switch 60, and a sealing member 70.

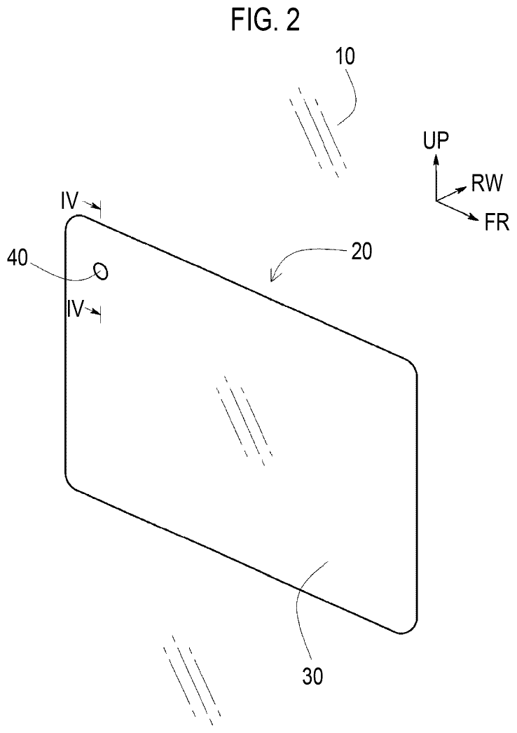

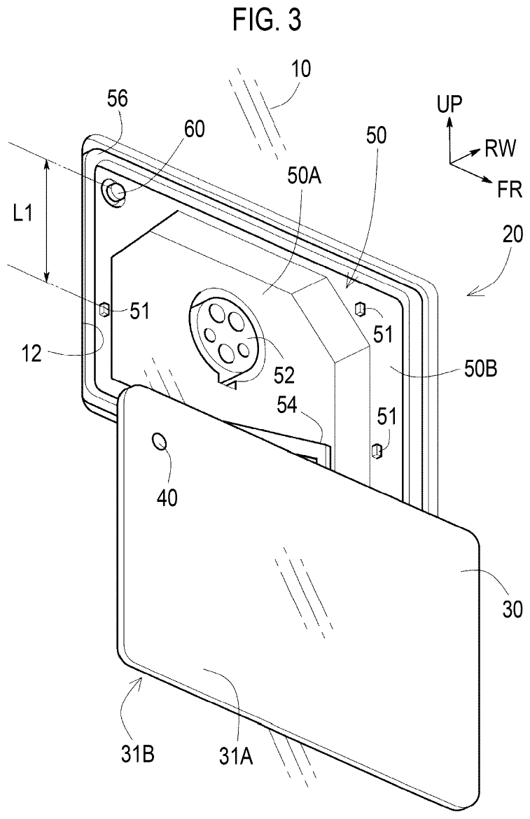

With reference to FIG. 3, an opening portion 12 is provided on the fender panel 10. A charging box 50 is installed in the opening portion 12. The lid opening and closing device 20 opens and closes the opening portion 12. That is, the opening portion 12 is covered with the lid plate 30. The lid plate 30 is moved from a closed state (refer to FIG. 2) to an open state (refer to FIG. 3) by an operation of the switch 60.

The charging box 50 includes a bottom surface 50A. The bottom surface 50A is disposed at a position recessed to an inner side in the vehicle width direction. An inlet 52 is disposed on the bottom surface 50A. A connector (not illustrated) of an external charger is connected to the inlet 52.

The charging box 50 includes a flange 50B. The flange 50B surrounds the bottom surface 50A. In addition, the flange 50B is disposed on an outer side in the vehicle width direction with respect to the bottom surface 50A. A sealing ring 56, the switch 60, and a stopper 51 are disposed on the flange 50B.

The sealing ring 56 is sealing member having an annular shape. The sealing ring 56 is installed on the flange 50B to surround the bottom surface 50A. With reference to FIG. 4, the sealing ring 56 is in contact with a back surface 31B of the lid plate 30. The lid plate 30 is in contact with the sealing ring 56, so that entry of water into the inlet 52 (refer to FIG. 3) is suppressed.

With reference to FIG. 3, the switch 60 is disposed in the opening portion 12. The switch 60 is disposed, for example, at a corner portion of the opening portion 12. With reference to FIG. 4, an attachment hole 55 for fixing the switch 60 is perforated in the charging box 50.

The switch 60 is provided to perform an opening and closing drive of the lid plate 30. That is, the lid opening and closing device 20 according to the present embodiment is equipped with an electric lid system. The lid opening and closing device 20 includes an arm 54 (refer to FIG. 3) that holds the lid plate 30. In addition, the lid opening and closing device 20 includes an actuator (not illustrated) that drives the arm 54. The actuator is driven by the operation of the switch 60.

For example, as illustrated in FIG. 2, in a case where the lid plate 30 is at a closed position, the opening portion 12 is closed by the lid plate 30. In a case where the switch 60 is pushed down via the cap 40 in the state, the actuator is driven. The lid plate 30 is moved to the outer side and a lower side in the vehicle width direction by the actuator and the arm 54.

In addition, in a case where the switch 60 is pushed down in the open state as illustrated in FIG. 3, the actuator is driven to move the lid plate 30 to the closed state as illustrated in FIG. 2. In the case, the lid plate 30 is moved until the back surface 31B of the lid plate 30 is in contact with the stopper 51.

In a state where the lid plate 30 and the stopper 51 are in contact with each other, it is difficult to further move a contact point of the lid plate 30 to the inner side in the vehicle width direction. Therefore, in a case where the lid plate 30 is bent to push down the switch 60 as in the related art, it is necessary to bend the lid plate 30 in a short region as indicated by a bending allowance L1. Instead of a structure in the related art with a large pushing-down load, in the lid opening and closing device according to the present embodiment, the switch 60 is pushed down by pushing down the cap 40.

### 2. Peripheral Structure of Cap

With reference to FIG. 4, the lid plate 30 includes the cap 40 and the sealing member 70. A through-hole 32 is perforated in the lid plate 30 at a portion facing the switch 60. The through-hole 32 is perforated in a thickness direction of the lid plate 30. The cap 40 is provided in the through-hole 32. The cap 40 is movable forward and backward inside the through-hole 32 in a penetration direction.

The cap 40 includes a flange 41 having a relatively large diameter and a protrusion portion 42 having a relatively small diameter. An exposed surface 41A is provided on the flange 41. Since the exposed surface 41A is a surface pressed by a user, the exposed surface 41A is also referred to as a pressing surface.

The protrusion portion 42 is in contact with the switch 60. The protrusion portion 42 pushes down the switch 60 as indicated by a broken line in accordance with the forward and backward movement of the cap 40. The actuator (not illustrated) is driven by the pushing down.

In addition, in a normal state where a finger does not touch the cap 40, a protruding end surface 42A of the protrusion portion 42 may be in contact with a protruding end surface 62A of the switch 60. That is, in a case where the lid plate 30 is in the closed state, the switch 60 and the cap 40 are in contact with each other.

In the manner, a surface management between the exposed surface 41A of the cap 40 and an exposed surface 31A of the lid plate 30 is performed by the switch 60. From a viewpoint of exterior design, an allowable range is set for a protrusion height and a depression depth of the exposed surface 41A of the cap 40 with respect to the exposed surface 31A of the lid plate 30. For example, the allowable range is set such that the exposed surface 31A and the exposed surface 41A have exteriors arranged on the substantially same plane. A position of the exposed surface 41A of the cap 40 is maintained at a constant value by bringing the switch 60 into contact with the cap 40. That is, the protrusion height and the depression depth are managed with high accuracy as compared to a case where the cap 40 is in a so-called “floating” state.

In order to achieve uniformity in exterior, colors of the exposed surface 41A of the cap 40 and the exposed surface 31A of the lid plate 30 may be the same.

The cap 40 is connected to the lid plate 30 via the sealing member 70. The sealing member 70 has a ring shape and surrounds the protrusion portion 42 of the cap 40. The sealing member 70 includes sealing portions 72, 74 and an elastic portion 76.

The sealing portion 72 is fitted into a stepped portion 34 of the lid plate 30. In addition, the sealing portion 74 is in contact with the protrusion portion 42 of the cap 40. For example, the sealing portion 74 is in contact with an outer peripheral surface 42B of the protrusion portion 42.

The elastic portion 76 is provided between the sealing portions 72, 74. The cap 40 is movable forward and backward due to the elasticity of the elastic portion 76.

As described above, with the lid opening and closing device 20 according to the present embodiment, the switch 60 can be pushed down without bending the lid plate 30.

### 3. Another Example of Present Embodiment

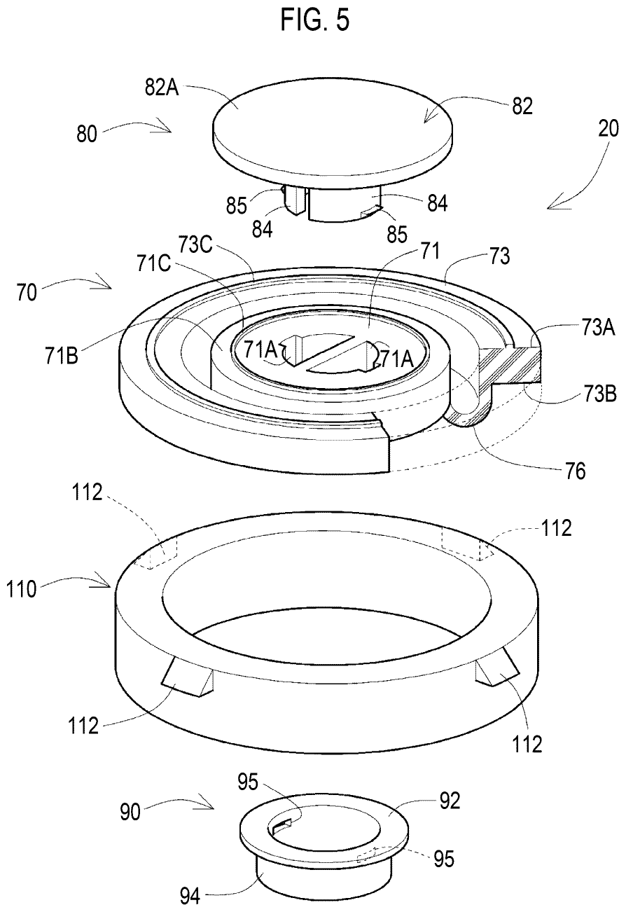

FIG. 5 illustrates a lid opening and closing device 20 according to another example of the present embodiment. In the example, the cap 40 includes an outer piece 80 and an inner piece 90. In addition, the lid opening and closing device 20 includes a holding ring 110. The charging box 50, the switch 60, and the sealing ring 56 have the same structures as in FIGS. 1 to 4.

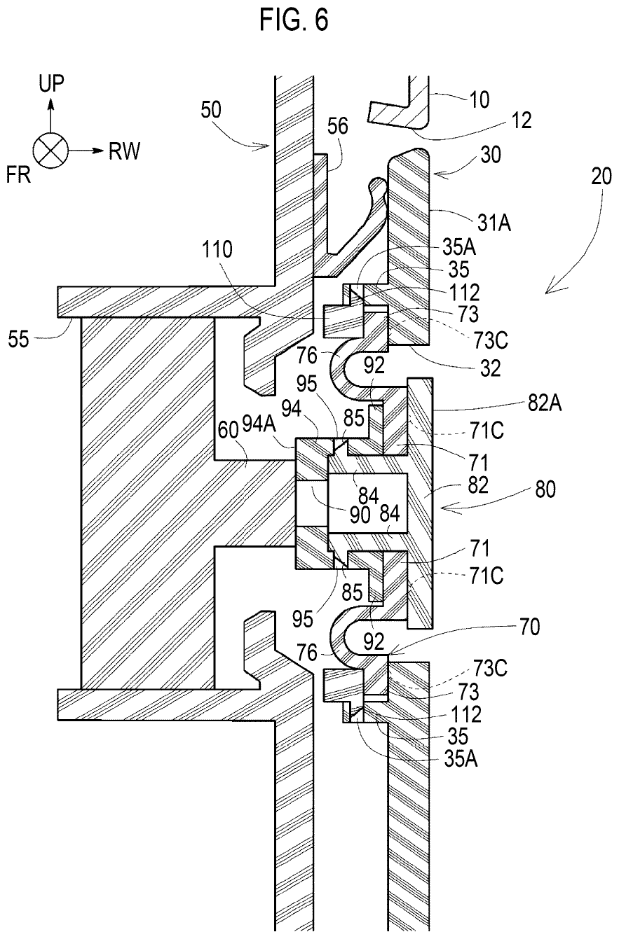

As will be described later, the lid opening and closing device 20 illustrated in FIGS. 5 and 6 has higher sealing properties than the lid opening and closing device 20 illustrated in FIG. 4. In FIG. 5, a cross section of a part of the sealing member 70 is illustrated in order to clarify the structure.

With reference to FIG. 6, a holding ring 35 is provided on the back surface of the lid plate 30 (a facing surface of an exposed surface 82A). An engagement hole 35A is perforated in the holding ring 35.

With reference to FIGS. 5 and 6, the outer piece 80 is exposed to an outside of the vehicle. The outer piece 80 includes a disk portion 82 and an arm 84. The disk portion 82 includes the exposed surface 82A. The exposed surface 82A is also referred to as a pressing surface.

The arm 84 extends from a back surface of the disk portion 82 (the facing surface of the exposed surface 82A). For example, the arm 84 extends perpendicularly with respect to the disk portion 82. For example, a pair of the arms 84 is provided on the outer piece 80. A claw 85 is provided at a protruding end of the arm 84.

The inner piece 90 faces the outer piece 80. The inner piece 90 includes a sleeve portion 94 and a flange 92. With reference to FIG. 6, a protruding end surface 94A of the sleeve portion 94 is in contact with the switch 60. The contact manages a relative position between the exposed surface 82A of the outer piece 80 and the exposed surface 31A of the lid plate 30.

In addition, the arm 84 of the outer piece 80 is inserted into the sleeve portion 94. An engagement hole 95 is perforated in the sleeve portion 94. The claw 85 of the arm 84 is engaged with the engagement hole 95.

With reference to FIG. 5, the sealing member 70 includes a center portion 71, an outer ring 73, and the elastic portion 76. The center portion 71 holds the cap 40 (that is, the outer piece 80 and the inner piece 90). The center portion 71 has a disk shape, and an insertion hole 71A is perforated in the thickness direction. For example, a pair of insertion holes 71A is provided in the center portion 71.

In addition, a seal protrusion 71C is provided on the center portion 71. The seal protrusion 71C is a protrusion having an annular shape that surrounds the insertion hole 71A.

The seal protrusion 71C is provided on a facing surface 71B with the disk portion 82 of the outer piece 80. Alternatively, in addition, the seal protrusion 71C may be provided on a facing surface with the flange 92 of the inner piece 90. That is, the seal protrusion 71C is provided on at least one of two of the facing surfaces.

The outer ring 73 surrounds the center portion 71. The outer ring 73 is also provided with a seal protrusion 73C. The seal protrusion 73C is a protrusion having an annular shape that surrounds the center portion 71. The seal protrusion 73C is provided on a facing surface 73A with the lid plate 30. Alternatively, in addition, the seal protrusion 73C may be provided on a facing surface 73B with the holding ring 110. That is, the seal protrusion 73C is provided on at least one of two of the facing surfaces.

The center portion 71 and the outer ring 73 are connected to the elastic portion 76. In other words, the elastic portion 76 connects the center portion 71 and the outer ring 73. The elastic portion 76 has an annular shape and is bent, for example, to be convex toward the switch 60 side.

The holding ring 110 is an annular member having substantially the same diameter as the outer ring 73. Claw 112 is provided on an outer peripheral surface of the holding ring 110. As will be described later, the claw 112 is engaged with the engagement hole 35A (refer to FIG. 6) of the lid plate 30.

With reference to FIGS. 5 and 6, the arm 84 of the outer piece 80 is inserted into the insertion hole 71A of the sealing member 70. Further, the protruding end of the arm 84 is inserted into the inner piece 90. In the case, the claw 85 of the arm 84 is engaged with the engagement hole 95 of the inner piece 90. By the engagement, the center portion 71 of the sealing member 70 is sandwiched between the outer piece 80 and the inner piece 90. More specifically, the center portion 71 is sandwiched between the flange 92 and the disk portion 82. In a case of the sandwiching, the seal protrusion 71C is crushed. That is, the sealing properties are ensured.

In addition, the outer ring 73 of the sealing member 70 is placed on the holding ring 110. In the state, the holding ring 110 is inserted into the holding ring 35 of the lid plate 30. In an insertion process, the claw 112 of the holding ring 110 is engaged with the engagement hole 35A of the lid plate 30. By the engagement, the outer ring 73 of the sealing member 70 is sandwiched between the lid plate 30 and the holding ring 110. In a case of the sandwiching, the seal protrusion 73C is crushed. That is, the sealing properties are ensured.

### 4. Other Embodiments

In FIGS. 1 to 6, the lid opening and closing device 20 is provided with respect to the charging box 50 of the fender panel 10. However, the lid opening and closing device 20 according to the present embodiment is not limited to the aspect. For example, the outer panel of the vehicle may be a quarter panel. In addition, a fuel inlet may be provided on the quarter panel instead of the charging box 50. That is, the lid opening and closing device 20 according to the present embodiment may be provided with respect to the fuel inlet at a rear side of the vehicle.

What is claimed is:

1. A lid opening and closing device that opens and closes an opening portion provided on an outer panel of a vehicle, the lid opening and closing device comprising a plate covering the opening portion, wherein:
a switch for performing an opening and closing drive of the plate is disposed in the opening portion;
a through-hole is perforated in the plate at a portion facing the switch; and
a cap movable forward and backward inside the through-hole in a penetration direction is further provided on the plate.

2. The lid opening and closing device of a vehicle according to claim 1, wherein the cap is connected to the plate via a sealing member that seals the through-hole.

3. The lid opening and closing device of a vehicle according to claim 2, wherein the switch and the cap are in contact with each other in a case where the plate is in a closed state.

4. The lid opening and closing device of a vehicle according to claim 2, wherein:
the cap includes an outer piece exposed to an outside of the vehicle and an inner piece facing the outer piece; and
the sealing member is sandwiched between the outer piece and the inner piece.

5. The lid opening and closing device of a vehicle according to claim 2, wherein:
the sealing member includes a center portion that holds the cap, an outer ring that surrounds the center portion, and an elastic portion that connects the center portion and the outer ring; and
the lid opening and closing device further includes a holding ring configured to sandwich the outer ring together with the plate.

6. The lid opening and closing device of a vehicle according to claim 5, wherein the outer ring is provided with a seal protrusion having an annular shape on at least one of a facing surface with the plate or a facing surface with the holding ring.
